(19) United States
(12) Patent Application Publication
(10) Pub. No.: US 2007/0056931 A1
(43) Pub. Date: Mar. 15, 2007

(54) Replaceable arc splitter cassette for a circuit breaker and circuit breaker having a replaceable arc splitter cassette

(76) Inventor: Sezai Turkmen, Berlin (DE)

Correspondence Address: HARNESS, DICKEY & PIERCE, P.L.C., P.O.BOX 8910, RESTON, VA, 20195, US

(21) Appl. No.: 11/516,527

(22) Filed: Sep. 7, 2006

(30) Foreign Application Priority Data
Sep. 8, 2005 (DE) 10 2005 043 396.0

(51) Int. Cl. H01H 33/00

(52) U.S. Cl. 218/149

(57) ABSTRACT

An apparatus is disclosed which allows for simple fitting and removal of the arc splitter plates of an arc-quenching chamber. A replaceable arc splitter cassette is proposed for a circuit breaker having a quenching chamber cover and an arc splitter stack. The arc splitter cassette further includes at least one interlocking element for fixing the arc splitter cassette to the circuit breaker in an interlocking manner, and at least one latching and/or snap-action connection element to fix the arc splitter cassette to the circuit breaker without screws for the switching operation.

### PRIORITY STATEMENT

The present application hereby claims priority under 35 U.S.C. §119 on German patent application number DE 10 2005 043 396.0 filed Sep. 8, 2005, the entire contents of which is hereby incorporated herein by reference.

### FIELD

The invention generally relates to a replaceable arc splitter cassette for a circuit breaker having a quenching chamber cover and an arc splitter stack. For example, it may relate to one in which the quenching chamber cover and an arc splitter stack form a structural unit which can be removed jointly from the circuit breaker. The arc splitter cassette may include, for example, at least one interlocking element for the purpose of fixing the arc splitter cassette to the circuit breaker in an interlocking manner. In addition, the invention may generally relate to a circuit breaker having such an arc splitter cassette.

### BACKGROUND

Air-breaking low-voltage switching devices, such as low-voltage circuit breakers, require an arc-quenching device for their operation in order to cause switching arcs which are occurring to be quenched without impairing the circuit breaker itself and adjacent parts of the assembly or other modules. Otherwise, there is the risk of the hot and therefore ionized arc gases causing electrical flashovers or bringing about other damage.

Predominantly in the case of small compact circuit breakers, it is conventional to provide a shaft in the breaker housing into which an arc splitter stack is inserted as the arc-quenching device and which is covered by a quenching chamber cover. With this design, in terms of the connection between the arc-quenching device and the main body of the circuit breaker and the connection between the individual parts thereof, the object set is in principle to seal the technically required gaps and joins against the passage of ionized arc gases and to prevent electrical flashovers as a result of any gases which nevertheless emerge. In this regard, particular attention should also be paid to the connection of the quenching chamber cover to the quenching chamber shaft.

The document DE 296 173 58 U1 has disclosed an arc-quenching chamber for a low-voltage circuit breaker having a blowout damper, to be inserted into the upper part of the housing of the arc-quenching chamber, for cooling and deionizing arc gases occurring during switching, which blowout damper has a two-part design. The main body of the blowout damper is inserted from above into the housing of the arc-quenching chamber and rests on the upper edges of the arc splitter plates, as a result of which these arc splitter plates are fixed vertically. A closure plate covers the main body of the blowout damper and holds it fixedly in its position. For this purpose, it is advantageously designed to be flexible and is provided with latching tongues, which engage in guide grooves provided close to the opening in the quenching chamber housing.

The document DE 100 38 642 A1 has also disclosed a chamber cover fixing for arc-quenching chambers in low-voltage switching devices. The document has disclosed an arc-quenching chamber having arc splitter plates, to which an arc-quenching chamber cover can be fitted or removed as a separate part. The arc-quenching chamber cover is in this case fixed to the arc-quenching chamber without any screws by use of guide elements and latching elements which can be inserted one inside the other. For this purpose, a housing clip is arranged on the front side on the upper part of the arc-quenching chamber housing, it being possible for a snap-action tongue, which is fixedly connected to the arc-quenching chamber cover, to be inserted beneath this housing clip.

Arranged on that side of the arc-quenching chamber cover which is opposite the snap-action tongue is a withdrawable part, which is in the form of a flat protrusion of the arc-quenching chamber cover. This withdrawable part can be inserted into a housing guide in that part of the arc-quenching chamber housing which is opposite the housing clip. During fitting, first the withdrawable part is pushed into the housing guide, then the arc-quenching chamber cover is pressed onto the arc-quenching chamber and finally inserted the direction of the housing clip, with the result that the snap-action tongue is guided through beneath the housing clip and snapped in behind it. This embodiment assumes that the arc-quenching chamber cover can be tilted during fitting.

One further variant for a chamber cover fixing is described in the document DE 100 49 726 A1. In this variant, too, the arc-quenching chamber cover is in the form of a separate component. Provision is made for this arc-quenching chamber cover to have on its front side in the insertion direction, a tongue, which extends at right angles to the insertion direction and essentially over the entire width of the arc-quenching chamber cover and can be inserted into a pocket in the housing of the arc-quenching chamber. At the opposite end of the arc-quenching chamber cover, lateral guide tabs are arranged such that, when the arc-quenching chamber cover is inserted, they enter guides which are arranged in the housing of the arc-quenching chamber. In addition, the housing of the arc-quenching chamber or of the arc-quenching chamber cover has one or more spring-loaded catches or latching grooves for accommodating the latter in order to lock the arc-quenching chamber cover.

The document EP 0 912 984 B1 describes an arc-quenching chamber for low-voltage circuit breakers, the quenching chamber housing having interlocking connection elements in the form of at least one horizontal, tab-like projection on the upper edge of at least one of the walls of the quenching chamber housing, and the quenching chamber cover having at least one claw-like protrusion for the purpose of surrounding this tab-like projection. For final fixing purposes, a hole is introduced both into the quenching chamber cover and into an integrally formed section of the quenching chamber housing, it being possible for a fixing screw to be inserted into the hole, with which fixing screw the entire arrangement can be fixed in the circuit breaker.

The document DE 101 49 019 C1 has disclosed an arc-quenching device for low-voltage switching devices, it being possible for a structural unit comprising an arc-quenching chamber cover and arc splitter plates to be inserted jointly into the switching device. In order to fix this structural unit, a web-shaped insertion tongue is provided on one side of the arc-quenching chamber cover and is inserted into a corresponding cutout in the arc-quenching chamber, which is integrated in the switching device. For the final fixing of the arc-quenching device, a leadthrough opening is provided for a fixing screw, by means of which the arc-quenching device is fixed in the arc-quenching chamber.

### SUMMARY

In at least one embodiment of the present invention, an apparatus is proposed which allows for simple fitting and removal of the arc splitter plates of an arc-quenching chamber. In particular, the apparatus should have a user-friendly design and should avoid faults during handling in a preventative manner.

The arc splitter cassette according to at least one embodiment of the invention comprises a quenching chamber cover and an arc splitter stack, which form a structural unit which can be removed jointly from the circuit breaker. The arc splitter cassette can be placed on or in a quenching chamber which is integrated in the circuit breaker. The quenching chamber cover and the arc splitter stack are preferably detachably connected to one another fixedly and/or rigidly and/or such that they can be displaced with respect to one another. The arc splitter stack is preferably fixed to the quenching chamber cover via insulating plates, which accommodate the arc splitter plates and the quenching chamber cover between them, at least in sections.

The arc splitter cassette has at least one interlocking element for the purpose of fixing the arc splitter cassette to the circuit breaker in an interlocking manner. The interlocking element is preferably in the form of a coupling part and/or cutout on or in the arc splitter cassette. When the arc splitter cassette is installed, the interlocking element interacts with an interlocking element of the circuit breaker, in particular the quenching chamber of the circuit breaker, having a complementary receptacle geometry, with the result that an interlocking connection is made between the interlocking elements.

According to at least one embodiment of the invention, at least one latching and/or snap-action connection element is provided on the arc splitter cassette, with the result that the arc splitter cassette can be fixed to the circuit breaker, in particular the quenching chamber of the circuit breaker, without any screws. The arc splitter cassette, which is fixed to the circuit breaker, in particular to the quenching chamber of the circuit breaker, via the at least one interlocking element and the at least one latching and/or snap-action connection element, is finally stopped for the switching operation of the circuit breaker, with the result that, in particular, no further screws or similar fixing means are required. The interlocking element and/or the at least one latching and/or snap-action connection element are preferably arranged, in particular integrally formed, on the quenching chamber cover.

In this case, at least one embodiment of the invention is based on the consideration that apparatuses in which the arc splitter stack and the quenching chamber cover need to be fitted as separate components are no longer accessible on the market and are problematic for the customer in terms of handling. Arc-quenching chambers which are in the form of a structural unit comprising a quenching chamber cover and an arc splitter stack are fixed to the circuit breaker using fixing screws in the known prior art. In this case, the screws need to be attached such that they cannot be lost since a very high degree of safety from loose parts is necessary, particularly in the arc chamber area. The known apparatuses therefore require a high degree of complexity in terms of design, during fitting and during removal of the structural unit.

In one example embodiment, at least one interlocking element is formed so as to protrude, in particular protrude at right angles, from the underside of the quenching chamber cover. The functional faces of the interlocking element are preferably designed to be parallel or essentially parallel to the longitudinal and/or transverse extent of the quenching chamber cover, in particular the functional faces of the interlocking element are arranged parallel, offset in terms of height, with respect to the resting faces of the quenching chamber cover, with which the quenching chamber cover is placed onto the circuit breaker during fitting. These resting faces are likewise arranged on the underside of the quenching chamber cover, the top face which faces the arc splitter stack being understood to be the underside.

Expediently, the interlocking element or elements is or are designed to be pushed along an insertion direction into or onto one or more interlocking elements of the circuit breaker. The arc splitter cassette is therefore in particular in the form of a structural unit which can be pushed onto the circuit breaker.

Provision is preferably made for the interlocking element and/or elements or the arc splitter cassette to have a design such that, when the arc splitter cassette is inserted, a movement at right angles to the insertion direction is blocked. This is preferably achieved by interacting functional faces on the interlocking elements of the arc splitter cassette and of the circuit breaker, which are aligned parallel to the insertion direction.

In one example embodiment, a first interlocking element is arranged and/or integrally formed in the rear (in the insertion direction) end section of the quenching chamber cover. The first interlocking element is preferably arranged and/or integrally formed at right angles to the insertion direction centrally on the quenching chamber cover. This design ensures that the operator, when fitting the arc splitter cassette, does not need to take care of interlocking elements in the edge region of the sides of the quenching chamber cover which are arranged parallel to the insertion direction, as is known from the other prior art, but in particular only needs to position and insert a single central member.

In one example embodiment, the first interlocking element is in the form of an inverted T-shaped insertion element. In this case, the vertical web of the “T” acts as an extension between the quenching chamber cover and the horizontal web. The upper sides of the horizontal web of the “T” which face the vertical web form the functional faces of the interlocking element which block a movement of the installed arc splitter cassette at right angles to the insertion direction. As an alternative, any interlocking element which has similarly designed functional faces, in particular functional faces, which are arranged such that they are vertically offset with respect to the underside of the quenching chamber cover, can be used.

In one expedient development of at least one embodiment of the apparatus, a web-like insertion tongue is provided as a second interlocking element. This web-like insertion tongue preferably extends as a protrusion on a side face of the quenching chamber cover, the protrusion in particular being integrally formed. The web-like insertion tongue preferably extends over the entire width of the side face.

It is furthermore advantageous if the interlocking elements are arranged and/or integrally formed on two opposite sides of the arc splitter cassette and/or of the quenching chamber cover. In particular, it is advantageous if the first and the second interlocking elements are placed on those sides of the quenching chamber cover which are opposite one another in the insertion direction.

The at least one latching and/or snap-action connection element is or are either formed as a latching and/or snap-action element or as corresponding receptacles for these. However, it may be advantageous for manufacture and the selection of materials if the latching and/or snap-action elements are arranged, in particular integrally formed, in or on the quenching chamber cover. For detachable locking of the arc splitter cassette, in particular in the insertion direction, provision is preferably made for the latching and/or snap-action connection elements to be placed on two opposite sides of the quenching chamber cover. These opposite sides are preferably arranged parallel to the insertion direction.

In one example embodiment, the latching elements are in the form of two latching tabs, which are placed opposite one another on those sides of the quenching chamber cover which are arranged parallel to the insertion direction. These latching tabs are in particular designed to be flexibly resilient and/or arranged in a resilient manner with respect to one another in a direction which is at right angles or is essentially at right angles to the insertion direction. Provision may advantageously be made for the latching tabs to be formed in the rear (in the insertion direction) end section of the quenching chamber cover, to be precise in particular at the height of the first interlocking element. The latching tabs are preferably arranged such that, with the first interlocking element completely inserted, the latching tabs enter into the locking position.

In order to realize the resilient flexibility of the latching tabs, slot-like cutouts are preferably arranged in the rear end section of the quenching chamber cover which in particular are aligned parallel to the insertion direction.

In one preferred development, the quenching chamber cover and the arc splitter stack are preferably connected to one another in an undetachable manner and at the same time such that they can be displaced in relation to one another, via the insulating plates. This design has the advantage that the arc splitter cassette can be handled easily during fitting and removal and, at the same time, it is ensured that the user only needs to fit a single assembly. The displacement direction for the mutual displacement of the quenching chamber cover and the arc splitter stack is preferably designed to be parallel to the insertion direction of the quenching chamber cover into the circuit breaker. It is particularly preferred if the arc splitter stack with the insulating plates forms a first rigid unit, which is arranged such that it can be displaced with respect to the quenching chamber cover, as a second rigid unit.

A circuit breaker, of at least one embodiment, has a replaceable arc splitter cassette as has been described above, a quenching chamber shaft and/or a quenching chamber having a matching connection geometry for accommodating the arc splitter cassette being provided. The circuit breaker is preferably in the form of an air-breaking low-voltage circuit breaker.

### BRIEF DESCRIPTION OF THE DRAWINGS

One example embodiment of the invention will be explained in more detail below with reference to a plurality of drawings, in which:

FIG. 1 shows a schematic, three-dimensional illustration of a section of a low-voltage circuit breaker with an inserted arc splitter cassette as an example embodiment of the invention;

FIG. 2a shows a schematic, three-dimensional illustration of the cover of the arc splitter cassette in FIG. 1, in a view from below;

FIG. 2b shows a schematic, three-dimensional illustration of the arc splitter cassette in FIG. 1 with the arc splitter stack fixed thereto, in a view from below;

FIG. 2c shows a schematic, three-dimensional illustration of the arc splitter cassette in FIG. 1 with the arc splitter stack fixed thereto, in a side view;

FIG. 3 shows a schematic plan view from the side of the low-voltage circuit breaker in FIG. 1;

FIG. 4 shows a schematic sectional illustration along the section line A-A in FIG. 3;

FIG. 5 shows a schematic sectional illustration along the section line B-B in FIG. 3; and

FIG. 6 shows a schematic sectional illustration along the section line C-C in FIG. 3.

### DETAILED DESCRIPTION OF THE EXAMPLE EMBODIMENTS

Mutually corresponding parts are always provided with the same reference symbols in all of the figures.

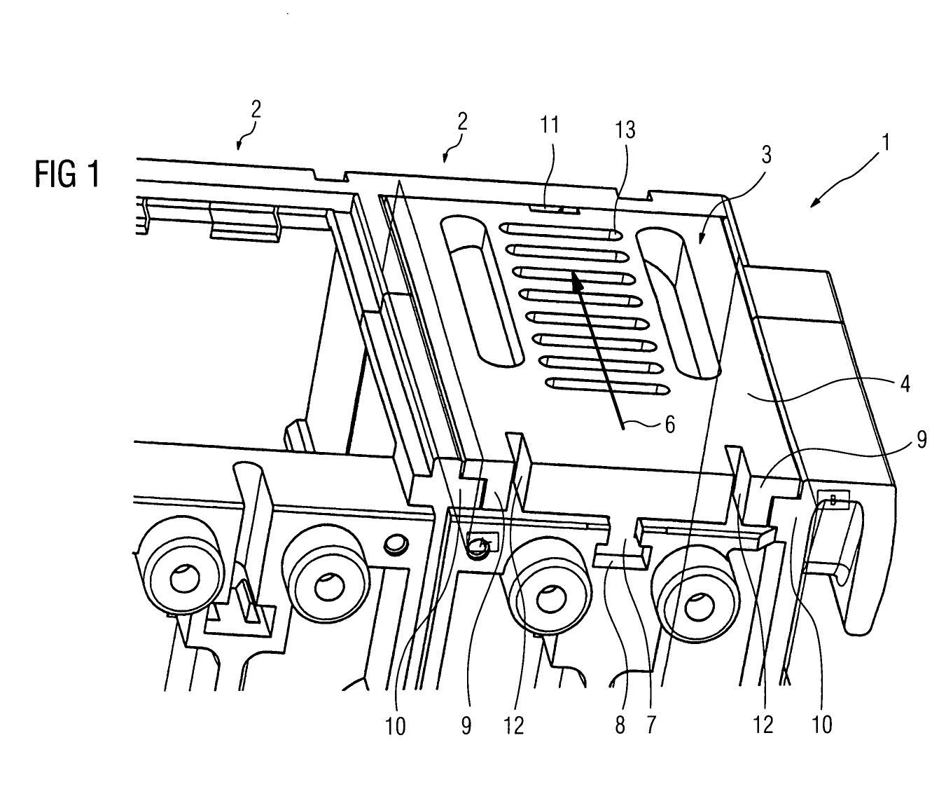

FIG. 1 shows a schematic 3D view at an angle from above of a detail of a low-voltage circuit breaker 1. The low-voltage circuit breaker 1 is in the form of a three-pole breaker and has three poles 2, which are arranged next to one another and of which only two are shown in this illustration. An arc splitter cassette 3 is inserted into the pole 2 which is arranged on the right-hand side in the illustration in FIG. 1. The arc splitter cassette 3 includes a quenching chamber cover 4 and an arc splitter stack 5, which is hidden in the illustration in FIG. 1 by the quenching chamber cover 4. The quenching chamber cover 4 is arranged on the upper side of the low-voltage circuit breaker 1 and is aligned parallel to it in its areal extent.

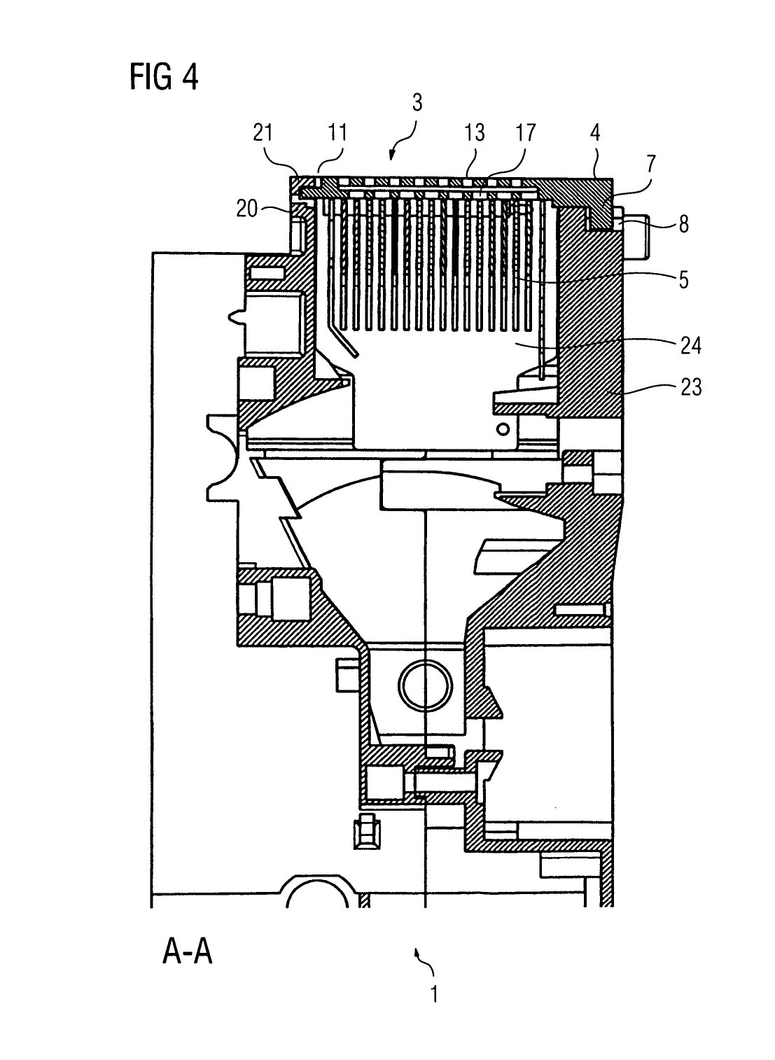

During fitting, the arc splitter cassette 3 is inserted into a quenching chamber 24 provided for this purpose in the low-voltage circuit breaker 1 (FIG. 4), and at least the quenching chamber cover 4 is pushed in a locking manner onto the low-voltage circuit breaker 1 in the direction of the arrow 6, which indicates an insertion direction. The quenching chamber cover 4 has an insertion element 7, which is integrally formed on the underside of the quenching chamber cover 4, centrally on the side facing the viewer in FIG. 1. This insertion element 7 is inserted into a receptacle 8, which has a complementary design to the insertion element 7, whilst the quenching chamber cover 4 is inserted in a locking manner. The insertion element 7 and the receptacle 8 both have an inverted T-shaped functional contour.

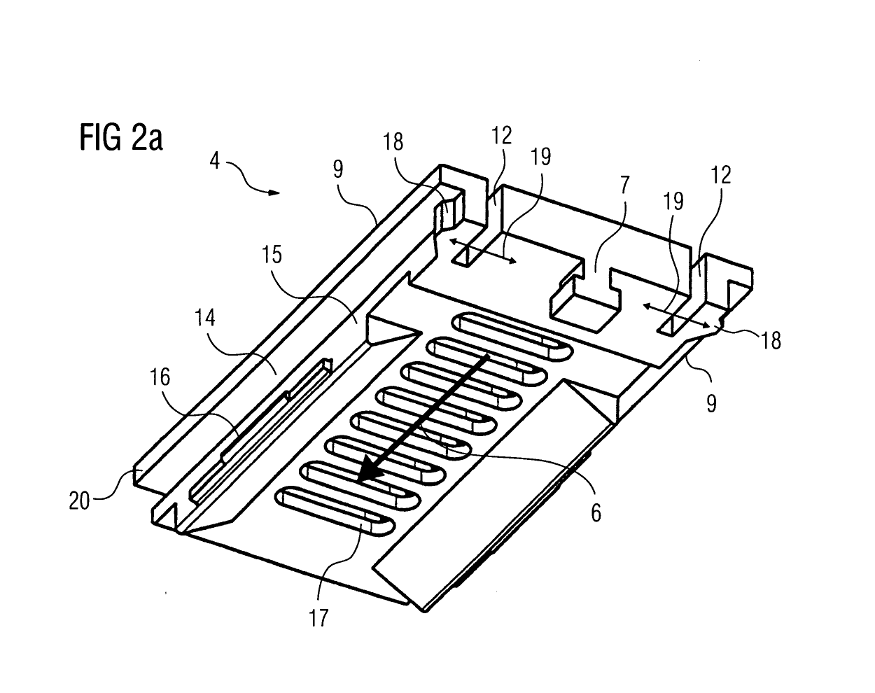

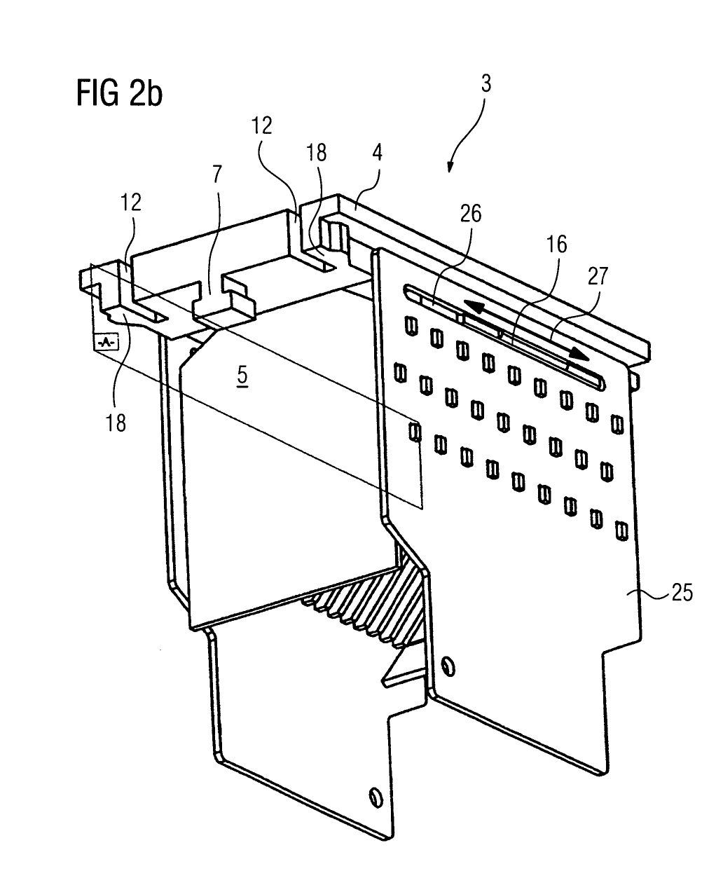

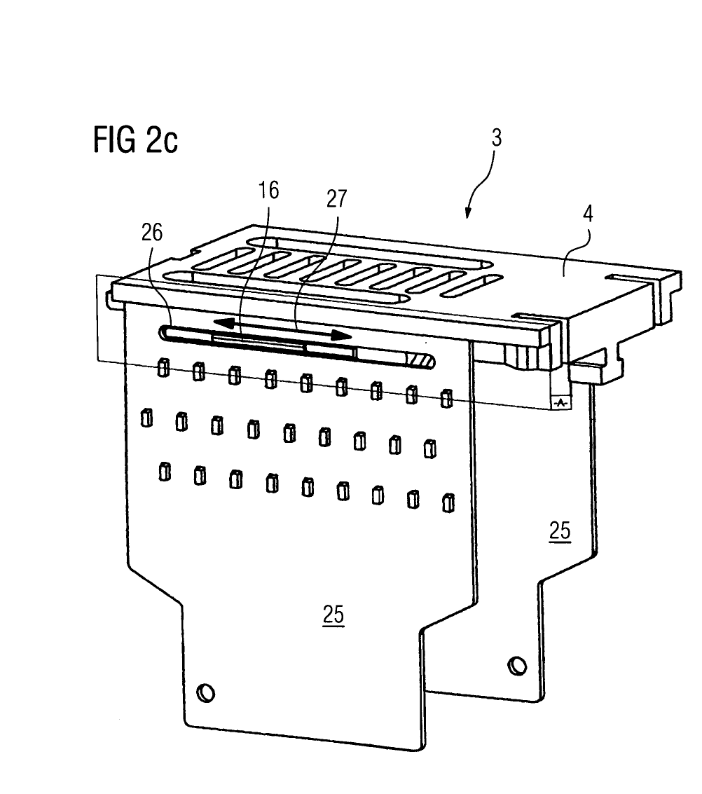

The edge sections of the quenching chamber cover 4 parallel to the insertion direction 6 are in the form of guide sections 9, having an inner contour which is rectangular at least in sections. The guide sections 9 rest or bear on resting angles 10, which are associated with the low-voltage circuit breaker 1. At its front (in the insertion direction 6) edge section, the quenching chamber cover 4 has a manipulator cutout 11, which is open in the insertion direction 6 and towards the top and into which a manipulator, for example a screwdriver, can be inserted in order to lever the quenching chamber cover 4 off from the low-voltage circuit breaker 1 in the opposite direction to the insertion direction 6. At the rear (in the insertion direction 6) edge section of the quenching chamber cover 4, slots 12 are cut out, whose function will be explained below with reference to FIGS. 2a, b, c. Furthermore, the quenching chamber cover 4 has outlet openings 13 on its upper side such that the quenching chamber 24 communicates with the surrounding environment.

FIG. 2a shows the quenching chamber cover 4 in FIG. 1 without the arc splitter stack 5 fixed thereto, in a schematic, three-dimensional view at an angle from below. In this illustration, the T-shaped insertion element 7 can be seen more clearly. On the upper side and the underside of the T transverse limb, it has guide faces which are formed parallel to the insertion direction 6. The edge-side guide sections 9 have resting faces 14, which are formed parallel to the guide faces of the insertion element 7 and extend over the entire length of the quenching chamber cover 4. In addition, the guide sections 9 have bearing faces 15, which are arranged at right angles to the resting faces 14 and, whilst interacting with the resting angles 10 of the low-voltage circuit breaker 1, guide the quenching chamber cover laterally as it is inserted.

In the region of the bearing face 15, fixing devices 16 are provided which are used for fixing insulating walls 25 (cf. FIGS. 2b, c), to which the arc splitter stack 5 is fixed. Inlet openings 17 are provided on the underside of the quenching chamber cover 4 and communicate with the outlet openings 13.

In the rear insertion region of the quenching chamber cover 4, a laterally and outwardly pointing latching tab 18 is arranged on each bearing face 15. The latching tabs 18 are in this case positioned symmetrically opposite one another. The latching tabs 18 are designed such that they can be yielding with respect to one another in a spring-deflection direction 19, which is at right angles to or essentially at right angles to the insertion direction 6. This is achieved by the slots 12 which are arranged parallel to the insertion direction 6 in the rear edge region of the quenching chamber cover 4. The slots 12 divide off in each case one end section of the guide sections 9, on which in each case one of the latching tabs 18 is located and which can be deflected out together with the respective latching tab 18. At the front (in the insertion direction) edge region of the quenching chamber cover 4, an insertion tongue 20 is provided which extends over a large part of the width of the guide cover 4.

FIGS. 2b and 2c show the arc splitter cassette 3 with the arc splitter stack 5 fixed to the quenching chamber cover 4 via insulating plates 25. The insulating plates 25 extend at right angles from the underside of the quenching chamber cover 4 and in each case bear against the bearing faces 15 of the quenching chamber cover 4 with one fixing section facing the quenching chamber cover 4. The insulating plates 25 therefore form side walls, which are aligned parallel to the longitudinal sides of the quenching chamber cover 4 and are used for accommodating and fixing the arc splitter stack 5. In each case one guide slot 26, which is aligned parallel to the longitudinal extent of the quenching chamber cover 4 and in which the fixing devices 16 of the quenching chamber cover 4 engage, is introduced into the fixing section of the insulating plates 25.

The fixing devices 16 are in the form of web-like shaped-out sections, which are likewise aligned parallel to the longitudinal extent of the quenching chamber cover 4. The fixing devices 16 are arranged displaceably within the guide slots 26, with the result that the entire quenching chamber cover 4 can be displaced with respect to the insulating plates 25 in a displacement direction 27, which is aligned parallel to the longitudinal extent of the quenching chamber cover 4 and/or parallel to the insertion direction of the quenching chamber cover 4 into the circuit breaker. The guide slot 26 is closed at its ends, with the result that these ends form end stops for the displacement of the quenching chamber cover 4 in relation to the insulating plates 25.

A large number of rectangular receptacles 28 are introduced into an accommodating region of the insulating plates 25 which adjoins the fixing section, fixing tabs 29 of the individual arc splitter plates of the arc splitter stack 5 being suspended in said receptacles 28, and the arc splitter plates of the arc splitter stack 5 being arranged at right angles with respect to the insulating plates 25.

With this design, the insulating plates 25 are connected rigidly to the arc splitter stack 5 and are connected nondetachably but displaceably to the quenching chamber cover 4.

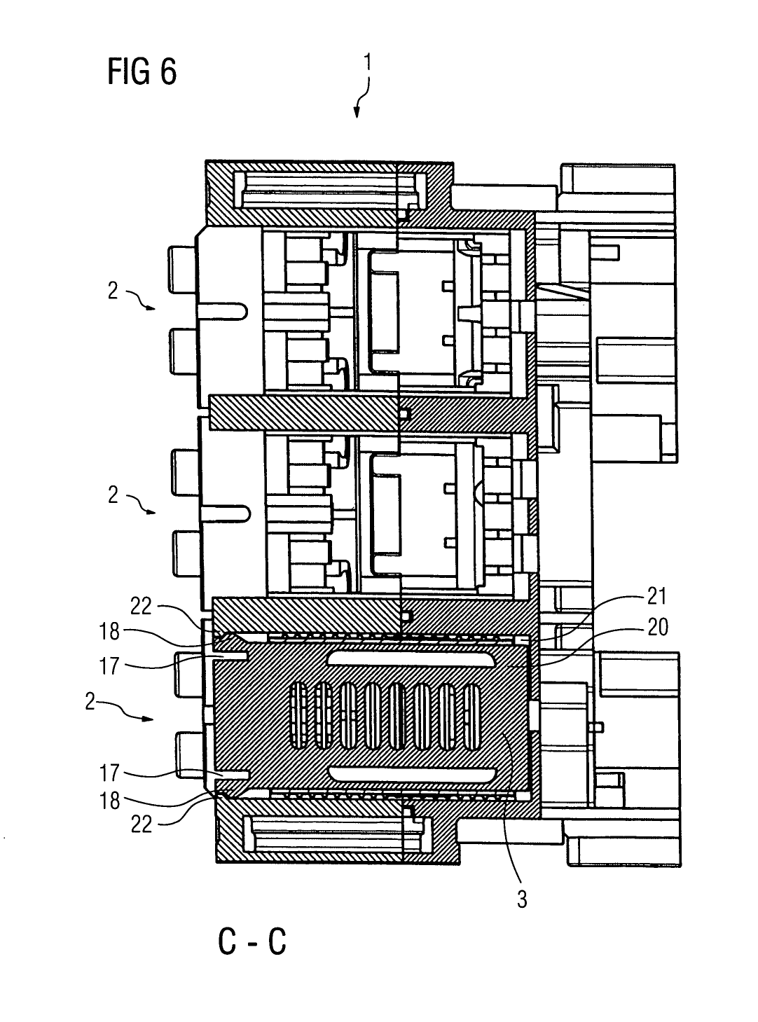

When the arc splitter cassette 3 is fitted in the low-voltage circuit breaker 1, the arc splitter cassette 3 is inserted into the quenching chamber 24. Then, the quenching chamber cover 4 is displaced in the insertion direction 6, with the result that the insertion tongue 20 is inserted into a cutout 21 (FIG. 4), which is complementary thereto, and the insertion element 7 is inserted into the receptacle 8 of the low-voltage circuit breaker 1. Once the insertion element 7 has been completely inserted into the receptacle 8, the latching tabs 18 latch in behind projections 22 provided for this purpose (FIG. 6), the projections being arranged on the resting angle 10. The insertion element 7 and the insertion tongue 20 provide an interlocking connection, with the result that a movement of the arc splitter cassette 3 at right angles to the insertion direction 6 is not possible.

The latching tabs 18, in interaction with the projections 22, cause the quenching chamber cover 4 to be locked in the opposite direction to the insertion direction 6. In order to remove the arc splitter cassette 3, a manipulator is inserted into the manipulator cutout 11, and the quenching chamber cover 4 is displaced in the opposite direction to the insertion direction and in opposition to the resistance of the connection formed by latching tabs 18 and projections.

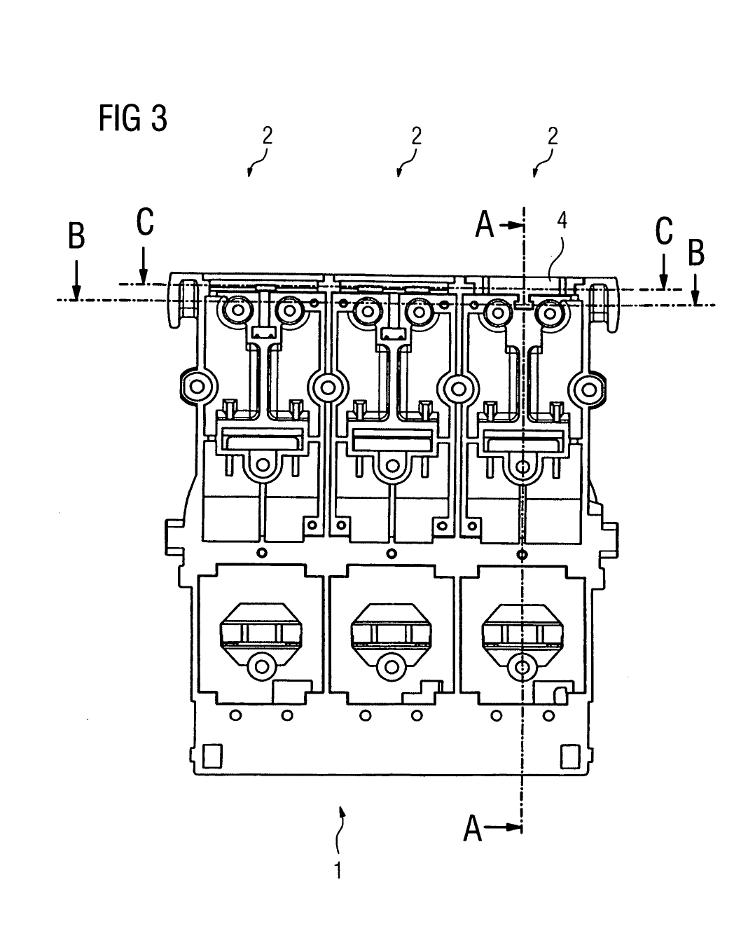

FIG. 3 shows a plan view of one side of the low-voltage circuit breaker 1 in FIG. 1 with the three poles 2, only the right-hand pole 2 being formed as an example embodiment of the invention.

FIG. 4 shows the low-voltage circuit breaker 1 along the section line A-A in FIG. 3. This illustration clearly shows the insertion tongue 20, which is in the form of a protrusion of the quenching chamber cover 4. The insertion tongue 20 has a rectangular cross section and engages in a cutout 21, which is likewise rectangular in cross section. The arc splitter stack 5 adjoins the underside of the quenching chamber cover 4 and is formed from a large number of arc splitter plates arranged at right angles with respect to the plane of the illustration. The arc splitter stack 5 is arranged within a quenching chamber 24 formed by a quenching chamber shaft 23.

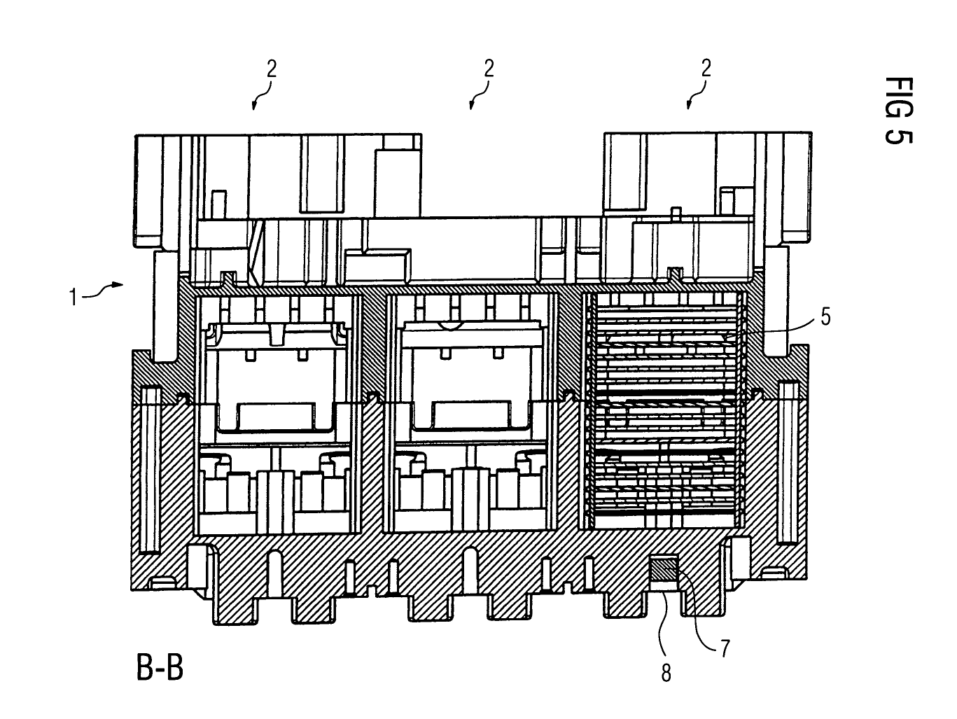

FIG. 5 shows a sectional illustration along the section line B-B in FIG. 3. In this illustration, the arc splitter stack 5 with the individual arc splitter plates is again clearly illustrated.

FIG. 6 shows a sectional illustration along the section line C-C in FIG. 3. In the front edge region of the quenching chamber cover 4, the insertion tongue 20 can be seen which rests on a resting face of the cutout 21 of the low-voltage circuit breaker 1. In the rear edge region of the quenching chamber cover 4, the latching tabs 18 are illustrated which are arranged in a locked position in the insertion direction 6 behind the projections 22. The projections 22 are in the form of shaped-out sections of the resting angle 10.

### LIST OF REFERENCE SYMBOLS

1 Low-voltage circuit breaker
2 Pole
3 Arc splitter cassette
4 Quenching chamber cover
5 Arc splitter stack
6 Arrow in the insertion direction
7 Insertion element
8 Receptacle
9 Guide sections
10 Resting angle
11 Manipulator cutout
12 Slots
13 Outlet openings
14 Resting face
15 Bearing face
16 Fixing means
17 Inlet openings
18 Latching tab
19 Arrow in the spring-deflection direction
20 Insertion tongue
21 Cutout
22 Projections
23 Quenching chamber shaft
24 Quenching chamber
25 Insulating plates
26 Guide slot
27 Displacement direction
28 Receptacles

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A replaceable arc splitter cassette for a circuit breaker, comprising:
a structural unit including,
a quenching chamber cover, and
an arc splitter stack, the structural unit being jointly removable from the circuit breaker,
at least one interlocking element to fix the arc splitter cassette to the circuit breaker in an interlocking manner; and
at least one of a latching and snap-action connection element to fix the arc splitter cassette to the circuit breaker without screws for the switching operation.

2. The arc splitter cassette as claimed in claim 1, wherein the at least one interlocking element is designed to protrude from the underside, which faces the arc splitter stack, of the quenching chamber cover in the direction of the arc splitter stack.

3. The arc splitter cassette as claimed in claim 1, wherein the at least one interlocking element is designed to be pushed along an insertion direction at least one of into and onto at least one interlocking element of the circuit breaker.

4. The arc splitter cassette as claimed in claim 3, wherein the at least one interlocking element is designed such that, when the arc splitter cassette is inserted, a movement of the arc splitter cassette at right angles to the insertion direction is blocked.

5. The arc splitter cassette as claimed in claim 3, wherein a first interlocking element is at least one of arranged and integrally formed at least one of in the rear end section of the quenching chamber cover and at right angles to the insertion direction centrally on the quenching chamber cover.

6. The arc splitter cassette as claimed in claim 5, wherein the first interlocking element is in the form of an inverted T-shaped insertion element.

7. The arc splitter cassette as claimed in claim 1, wherein a second interlocking element is in the form of a web-like insertion tongue.

8. The arc splitter cassette as claimed in claim 1, wherein the interlocking elements are at least one of arranged and integrally formed on two opposite sides of at least one of the arc splitter cassette and the quenching chamber cover.

9. The arc splitter cassette as claimed in claim 1, wherein the at least one element is formed at least one of as at least one of at least one latching element and at least one snap-action element and as at least one receptacle for at least one of at least one latching element and at least one snap-action element.

10. The arc splitter cassette as claimed in claim 1, wherein at least one of latching and snap-action connection elements are at least one of arranged and integrally formed on two opposite sides of at least one of the arc splitter cassette and the quenching chamber cover.

11. The arc splitter cassette as claimed in claim 3, wherein the at least one at least one of latching and snap-action connection element is designed to detachably lock at least one of the arc splitter cassette and the quenching chamber cover in the circuit breaker in the opposite direction to the insertion direction.

12. The arc splitter cassette as claimed in claim 3, wherein the latching connection elements are in the form of two latching tabs, which are arranged opposite one another on those sides of the quenching chamber cover which are at least one of arranged parallel to the insertion direction, formed in a resilient manner, and arranged in a resilient manner in a direction which is at least one of at right angles to and essentially at right angles to the insertion direction.

13. The arc splitter cassette as claimed in claim 12, wherein the latching tabs are formed in the rear end section of the quenching chamber cover.

14. The arc splitter cassette as claimed in claim 13, wherein the rear end section of the quenching chamber cover includes slot-like cutouts, arranged parallel to the insertion direction to permit the latching tabs to yield in a resilient manner.

15. The arc splitter cassette as claimed in claim 1, wherein the quenching chamber cover and the arc splitter stack are connected to one another in an undetachable manner.

16. The arc splitter cassette as claimed in claim 1, wherein the quenching chamber cover and the arc splitter stack are connected to one another so as to be displaceable in relation to one another.

17. A circuit breaker comprising a replaceable arc splitter cassette as claimed in claim 1, and at least one of a quenching chamber shaft and a quenching chamber, having a matching connection geometry for accommodating the arc splitter cassette.

18. The arc splitter cassette as claimed in claim 2, wherein the at least one interlocking element is designed to be pushed along an insertion direction at least one of into and onto at least one interlocking element of the circuit breaker.

19. A replaceable arc splitter cassette for a circuit breaker, comprising:
a quenching chamber cover;
an arc splitter stack;
at least one interlocking element to fix the arc splitter cassette to the circuit breaker in an interlocking manner; and
at least one of a latching and snap-action connection element, to fix the arc splitter cassette to the circuit breaker without screws.

20. A circuit breaker comprising a replaceable arc splitter cassette as claimed in claim 19.
